(19) United States
(12) Patent Application Publication
(10) Pub. No.: US 2004/0140874 A1
(43) Pub. Date: Jul. 22, 2004

(54) Switchgear comprising an electromagnetic tripping device

(76) Inventors: Wolfgang Leitl, Wenzenbach (DE); Christoph Weber, Ergoldsbach (DE)

Correspondence Address: HARNESS, DICKEY & PIERCE, P.L.C., P.O.BOX 8910, RESTON, VA, 20195, US

(21) Appl. No.: 10/476,594

(22) PCT Filed: May 21, 2002
(86) PCT No.: PCT/DE02/01824

(30) Foreign Application Priority Data
Jun. 1, 2001 (DE) 101 26 851.3

(51) Int. Cl. H01H 9/00

(52) U.S. Cl. 335/220

(57) ABSTRACT

An aim is to optimize the number of components required for a switchgear, and to ensure a variable arrangement for an electromagnetic tripping device arranged in the switchgear, with the highest amount of precision in terms of kinematics. To this end, the components of the switchgear, such as the trip coil and/or the armature and/or the tappet, are guided in bearings formed by parts of the housing.

The invention relates to a switching device having an electromagnetic release in accordance with the preamble of claim 1.

A switching device having an electromagnetic release is used, for example, for control, switching and command purposes. Suitable switching devices are, for example, a contactor, a relay, a power breaker, a circuit breaker or else a motor-protective circuit breaker. Furthermore, electromagnetic release technology may be used in a top-hat rail device having a switching function.

Such a switching device, in particular a circuit breaker, is known from EP 0 412 953 A2. The design of this switching device, and that of the electromagnetic release arranged within it, are complex and their configuration is dependent on the defined installation conditions.

Owing to the stringent technical and economic demands placed on such a switching device, the object of the present invention is, on the one hand, to optimize the number of components required for the switching device and its modules, and to provide a variable arrangement whilst at the same time maintaining as much precision as possible with regard to the kinematics of the electromagnetic release.

This object is achieved by a switching device having an electromagnetic release of the type mentioned initially, in which, according to the invention, the tripping armature and/or the plunger and/or the tripping coil are guided in bearings formed by parts of the housing.

Of primary importance here is the reduction, which can be achieved by the invention, in the number of components and the reduction, associated with this, in the possible time spent on and costs of design, manufacture, assembly and storage. Since the individual, interactive components are decoupled, fewer connecting means are required and a friction-reducing effect can be brought about affecting the functional properties of the electromagnetic release.

In this case, the bearings formed by parts of the housing are designed such that they serve the purpose of guiding, centering and bearing the tripping coil and/or the tripping armature and/or the plunger. The previously required insulating sleeve between the tripping coil and the tripping armature is accordingly no longer required, and this has a favorable influence on the thermal operating conditions.

Advantageously, the bearings are in the form of attachments to the housing. This results in a simple integral unit which can be produced as a casting or molding. The costs of manufacture and assembly of the individual components are thus advantageously reduced.

The reduced friction between the moving components, such as the tripping armature with the plunger and the associated bearings or the tripping armature and the plunger has proved advantageous in this context. This in turn results in an improved response for the electromagnetic release. It is also notable that the simplified assembly structure achieved here and its suitability for both manual and automated manufacture reduce the overall production costs.

In a further refinement, at least one of the bearings is in the form of a separate housing part and can be arranged in the housing such that it can be moved. This makes it possible particularly advantageously for different physical sizes of the electromagnetic release to be used. Furthermore, there is the option, by replacing the bearings, of using different bearing materials,

of making an adjustment, of compensating for tolerances and of selecting the bearing position such that an individual module, in particular the electromagnetic release, can in each case be adapted to different functions.

The housing expediently comprises two housing shells. It is thus possible for the tripping armature to be mounted such that it is matched, in a simple manner, and positioned in relation to a switching mechanism arranged in the switching device, since one housing shell is in each case integral.

The housing is preferably made of insulating material. Here, the insulating properties of the insulating material are sufficiently advantageous for it to satisfy the existing requirements for contact protection and, furthermore, for the components and modules to be electrically and thermally isolated from one another.

The magnet core, an intermediate piece and the magnet yoke are advantageously in the form of an integral unit. The unit produced here advantageously contributes to a reduction in the assembly time for the electromagnetic release.

Further advantages and details of the invention are explained in more detail below, by way of example, with reference to the drawing, in which:

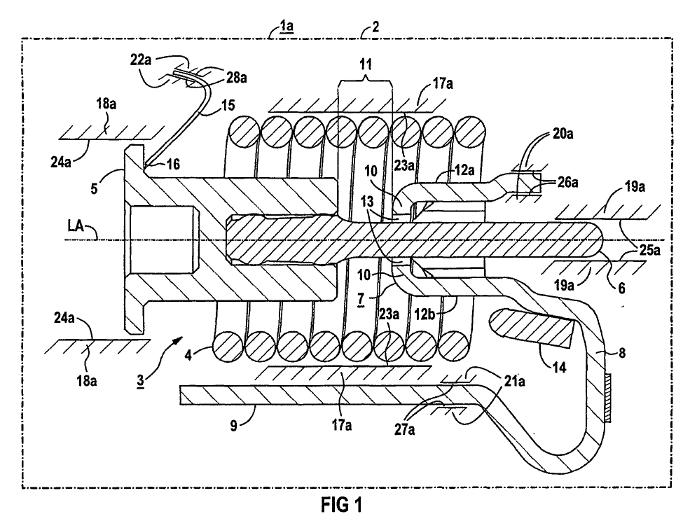

FIG. 1 shows a side view of a switching device having an electromagnetic release and having bearings formed by parts of the housing, and

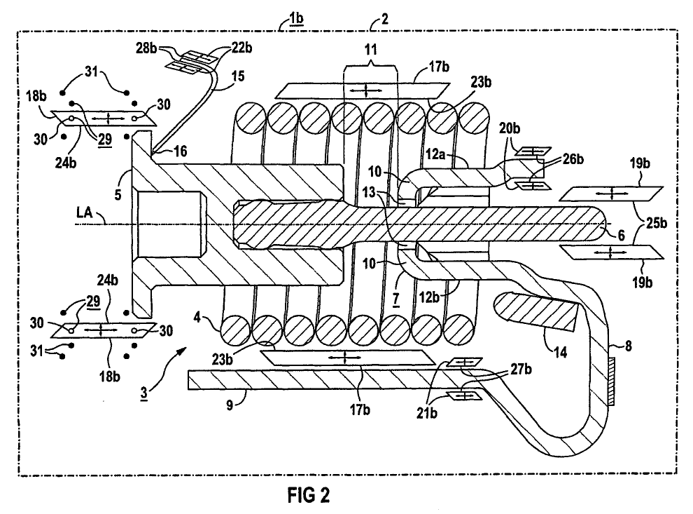

FIG. 2 shows a side view of a further switching device having an electromagnetic release and having moving bearings formed by separate housing parts.

In the text which follows, identical parts in the figures are provided with the same reference numerals or, as a guide, are provided with similar reference numerals.

The function of the switching device is not described in any more detail as it is adequately described in the prior art. This relates in particular to the electrical activation of a release and the mechanical coupling to a switching mechanism.

FIG. 1 shows, symbolically, a switching device 1a having a housing 2 and having an electromagnetic release 3.

The electromagnetic release 3 is provided with a tripping coil 4 which extends along an imaginary longitudinal axis LA. The tripping coil 4 has, on one side, a tripping armature 5 and a plunger 6 which is operatively connected to said tripping armature. The tripping armature 5 and the plunger 6 in this case form a unit. The operative connection is in this case a force-fitting connection. Alternatively, the operative connection may also be an interlocking connection or a connection using techniques such as soldering, bonding or welding.

On the other side opposite said one side, the tripping coil 4 has a magnet core 7, which, after an intermediate piece 8 in the form of an ear, merges with a magnet yoke 9. The intermediate piece 8 in the form of an ear acts, inter alia, as a stationary contact carrier. The magnet yoke 9 extends outside the tripping coil 4 axially parallel to the longitudinal axis LA in the direction of the tripping armature 5.

The magnet core 7 shown is U-shaped, and its base web 10 projects into the tripping coil 4 such that an air gap 11 is formed between it and the tripping armature 5.

The two limbs 12a, 12b of said magnet core 7 in this case run axially parallel to the longitudinal axis LA. The plunger 6 likewise runs along the longitudinal axis LA and is passed through an opening 13, which has been introduced in the center of the base web 10, in the magnet core 13. One coil end 14 of the tripping coil 4 is attached to the intermediate piece 8 using techniques such as soldering, bonding or welding. Alternatively, this connection may also be an interlocking- or force-fitting connection. By designing the magnet core 7 in this manner, a separate magnet core is no longer required.

The tripping armature 5 is operatively connected to a restraint spring 15 whose free end 16 acts on the side, facing the tripping coil 4, of the tripping armature 5. The tripping coil 4, the tripping armature 5, the magnet core 7, the intermediate piece 8 and the magnet yoke 9 are made of a conductor material, such as copper, steel, aluminum or a suitable alloy. The plunger 6 and the restraint spring 15 can be made of a conductive or else insulating material.

The tripping coil 4 is guided in a first bearing 23a, formed by first parts 17a of the housing 2, along the longitudinal axis LA. The same applies for the tripping armature 5 and the plunger 6, which are guided in a second and third bearing 24a and 25a, respectively, which comprise second and third parts 18a and 19a, respectively, of the housing 2. Furthermore, the magnet yoke 9 is held in a fourth and fifth bearing 26a and 27a, respectively, which are formed by fourth and fifth parts 20a and 21a, respectively, of the housing 2. In the same way, the restraint spring 15 is held in a sixth bearing 28a formed by sixth parts 22a of the housing 2.

The bearings 23a, 24a and 25a in the form of attachments to the housing 2 may be designed such that the tripping coil 4, tripping armature 5 and plunger 6 components are only partially or are completely enclosed. The respective radial region of the components is mounted in a corresponding manner.

The bearings 23a, 24a and 25a can be formed over the entire length of the component or only over a section or over more than one section. The same also roughly applies to the bearings 26a, 27a and 28a of the magnet yoke 9 and restraint spring 15 the components. The attachments are in this case connected to the housing using techniques such as soldering, bonding or welding and are in the form of injection moldings or moldings. The fact that an insulating sleeve, which is not shown here and which can be arranged between the tripping coil 4 and the tripping armature 5, is not required is advantageous here. The tripping coil 4 is accordingly arranged in the housing 2 in a self-supporting fashion, so to speak.

By using an easily assembled restraint spring 15 in the form of a leaf spring instead of a pressure or torsion spring at the time of final assembly, on the one hand, the number of different types of module can be reduced and, on the other hand, costs can be reduced. This advantage arises, inter alia, owing to the fact that the restraint spring 15 is not inserted until final assembly of the switching device 1a, 1b, and therefore depends on the respective variant of the embodiment.

The further switching device 1b shown in FIG. 2 differs from the switching device 1a shown in FIG. 1 in that at least one of the bearings 23b, 24b and 25b is in the form of a separate housing part and can be arranged in the housing 2 such that it can be moved. The same applies to the bearings 26b, 27b and 28b.

The bearings can be arranged such that they can be moved by means of a plug mechanism 29, for example. The plug mechanism 29 in this case has bolts 30 and cutouts 31 introduced as the opposing piece at a wide variety of points in the housing 2. The second parts 18b of the bearing 24b can in this case be positioned at a wide variety of points in the housing 2. The positioning can also be achieved, if required, by means of a shift mechanism based on a tongue and groove system. Conventional equivalents familiar from the prior art likewise fulfill the function of arranging the bearings such that they can be moved.

The two paragraphs below relate in a similar manner to FIGS. 1 and 2.

The bearings 23a to 28b have a friction-reducing surface and are generally arranged in two housing shells which are joined together to form the housing 2. The housing 2 may also be integral with a corresponding opening for introducing the components and modules. An insulating material is used for the housing 2. An insulating material is generally regarded as a plastic, in particular a thermosetting plastic or thermoplastic. A thermosetting plastic has particularly good heat resistance, a thermoplastic being suitable for finer applications.

The manner of the configuration, arrangement and embodiment of the idea presented above for bearing different components and modules can be used in an identical or modified configuration for circuit breakers, motor-protective circuit breakers or power breakers. In the same manner, it can also be used for an electromagnetic switching device or top-hat rail device, such as a contactor or a relay. The modules are in this case advantageously not assembled to form a complete electromagnetic release 3. At the same time, the bearings 23a-28b perform, completely or partially, the function of centering, guiding and bearing.

The embodiment variant as shown in FIG. 1 is particularly suitable for an electromechanical or electromagnetic switching device from a limited range of types. In contrast to this, the embodiment variant as shown in FIG. 2 may also be

used for those switching devices having an extensive range of types.

1. A switching device (1a, 1b) having a housing (2) and having an electromagnetic release (3) which has a tripping coil (4), a tripping armature (5) and a plunger (6) which is operatively connected to said tripping armature, the tripping coil (4) surrounding the tripping armature (5) and the plunger (6), and having a magnet core (7) at one end which merges with a magnet yoke (9),
characterized in that
the tripping coil (4) and/or the tripping armature (5) and/or the plunger (6) are guided in bearings (23a, 23b, 24a, 24b and 25a, 25b, respectively) formed by parts (17a, 17b, 18a, 18b and 19a, 19b, respectively) of the housing (2).

2. The release as claimed in claim 1,
characterized in that
the bearings (23a-28b) are in the form of attachments to the housing (2).

3. The release as claimed in either of claims 1 or 2,
characterized in that
at least one of the bearings (23a-28b) is in the form of a separate housing part and can be arranged in the housing (2) such that it can be moved.

4. The release as claimed in one of the preceding claims,
characterized in that
the housing (2) comprises two housing shells.

5. The release as claimed in one of the preceding claims, characterized in that
the housing (2) is made of insulating material.

6. The release as claimed in claim 1,
characterized in that
the magnet core (7), an intermediate piece (8) and the magnet yoke (9) are in the form of an integral unit.
